(19) United States
(12) Patent Application Publication
(10) Pub. No.: US 2012/0236362 A1
(43) Pub. Date: Sep. 20, 2012

(54) PRINTING SYSTEM, METHOD FOR CONTROLLING POWER OF PRINTING SYSTEM, AND PROGRAM

(75) Inventor: Taku Inoue, Machida-shi (JP)

(73) Assignee: CANON KABUSHIKI KAISHA, Tokyo (JP)

(21) Appl. No.: 13/419,889

(22) Filed: Mar. 14, 2012

(30) Foreign Application Priority Data
Mar. 16, 2011 (JP) 2011-057516

(51) Int. Cl. G06K 15/00

(52) U.S. Cl. 358/1.15

(57) ABSTRACT

The present invention improves a power saving effect by dynamically switching a power supply state of a plurality of drawing processing apparatuses. In a printing system including an information processing apparatus configured to receive at the same time a plurality of print jobs requiring drawing processing, a plurality of drawing processing apparatuses capable of switching power saving modes according to the instructions of the information processing apparatus, and a printing apparatus configured to print image information drawn by any of the drawing processing apparatuses, drawing processing on a page basis required for each received print job is allocated to any of a plurality of the drawing processing apparatuses after a series of printing processing for a plurality of the received print jobs is started. A corresponding drawing processing apparatus is instructed to dynamically switch a power supply state.

### BACKGROUND OF THE INVENTION

1. Field of the Invention

The present invention relates to a printing system which extracts a drawing command and an image included in page description language (PDL) using a plurality of data processing apparatuses and performs a raster image processor (RIP) process to convert the extracted drawing command into a raster image, a method for controlling power of the printing system, and a program.

2. Description of the Related Art

A printing system utilizing a digital printing machine performs PDL analysis of PDL job data input to the printing system using a raster image processor (RIP) controller to extract a drawing command and an image included in PDL and performs the RIP process to convert the extracted drawing command into a raster image. Thereafter, the raster image is output to a printer engine.

It is important for a high speed printing system used in commercial printing such as photographic printing and publishing printing to perform the RIP process of print data at a constant speed corresponding to a rated printing speed of a printing machine to ensure productivity. Accordingly, a technique is disclosed which performs a distributed RIP process using a plurality of RIP controller servers by a unit of a print job or a part of the print job (refer to Japanese Patent Application Laid-Open No. 2001-265556).

In the above printing system performing the distributed RIP process, reduction of power consumption of the RIP server is required from the viewpoint of cost and power saving. In the distributed RIP process of a commercial printing system, a requisite RIP server is energized and needs to be kept operable in order to maintain the throughput of the RIP process. A load is high particularly when a print job including pages with a large number of graphic objects is processed. Therefore such a job requires the distributed process using multiple RIP servers. On the other hand, the number of the RIP servers to be energized needs to be reduced from the viewpoint of power saving. A power saving technique in the commercial printing system needs to solve this trade-off.

Until now, following techniques have been proposed with regard to the power saving of the RIP process using a plurality of servers. In a case where a print job is input using a plurality of printers, if the print job input to a printer in operation does not exceed a threshold value, the print job is executed using the printer in operation. If the print job exceeds the threshold value, the print job is transmitted to a printer in power saving (refer to Japanese Patent Application Laid-Open Nos. 2001-331293 and 2006-088590). A job which does not need to be immediately printed is collectively printed along with other jobs to prolong the time of standby state, reducing power consumption (refer to Japanese Patent Application Laid-Open Nos. 2004-074530 and 2010-214697). A print job is input to a server which is low in power consumption among servers capable of completing process within a time limit set for each print job (refer to Japanese Patent Application Laid-Open No. 2004-046774). Further, a print job may be previously scanned to estimate time required for the RIP process of each page in advance (refer to Japanese Patent Application Laid-Open No. 2006-155308).

The power saving techniques discussed in Japanese Patent Application Laid-Open Nos. 2001-331293, 2006-088590, 2004-074530, and 2010-214697 presume that a printer is used in office and do not consider the throughput of the RIP process, so that the techniques cannot be applied to the commercial printing system. The power saving technique discussed in Japanese Patent Application Laid-Open No. 2004-046774 simply calculates process time for each print job from the number of pages of the print job and does not consider process load for each page.

Thus, the conventional printing system has a problem in that power control is not appropriately executed for each RIP processing unit and wasteful power is consumed in a case where the RIP process of each page jobs is carried out with a plurality of the RIP processing units collaborating with one another.

### SUMMARY OF THE INVENTION

The present invention provides a mechanism for improving a power saving effect by dynamically switching a power supply state between a drawing processing apparatus used for drawing each page and a drawing processing apparatus not used for drawing each page among a plurality of drawing processing apparatuses.

According to an aspect of the present invention, a printing system includes an information processing apparatus configured to receive at the same time a plurality of print jobs requiring drawing processing, a plurality of drawing processing apparatuses capable of switching power saving modes according to the instructions of the information processing apparatus, and a printing apparatus configured to print image information drawn by any of the drawing processing apparatuses, in which the information processing apparatus includes, an allocation unit configured to allocate drawing processing on a page basis required for each received print job to any of a plurality of the drawing processing apparatuses after a series of printing processing for a plurality of the received print jobs is started and a control unit configured to instruct a corresponding drawing processing apparatus to dynamically switch a power supply state between the drawing processing apparatus used for drawing each page allocated by the allocation unit and the drawing processing apparatus not used for drawing each page among a plurality of the drawing processing apparatuses.

According to the present invention, a power saving effect can be improved by dynamically switching a power supply state between a drawing processing apparatus used for drawing each page and a drawing processing apparatus not used for drawing each page among a plurality of drawing processing apparatuses.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram describing a configuration of a printing system according to the present exemplary embodiment.

FIG. 2 is an operational sequence diagram of the printing system illustrated in FIG. 1.

FIG. 3 is a flow chart describing a method for processing data in the printing system.

FIG. 4 is a flow chart describing a method for processing data in the printing system.

FIG. 5 is a flow chart describing a method for processing data in the printing system.

FIG. 6 is a schematic diagram illustrating a state of the power supply of each RIP node in the printing system.

FIG. 7 is a schematic diagram illustrating shift in state of the power supply of the RIP node.

FIG. 8 is a block diagram of a power supply mechanism of the RIP node in the printing system.

FIG. 9 is a diagram illustrating a screen for state of power consumption of the printing system.

FIG. 10 is a schematic diagram illustrating a state of the power supply of each RIP node in the printing system.

FIG. 11 is a diagram illustrating a screen for state of power consumption of the printing system.

FIG. 12 is a power option setting screen for the printing system.

FIG. 13 is a block diagram illustrating a configuration of the RIP node in the printing system.

FIG. 14 is a block diagram describing a configuration of the printing system.

FIG. 15 is a schematic diagram illustrating a state of the power supply of each RIP node in the printing system.

FIG. 16 illustrates an example of the number of spooled pages monitored by the printing system.

FIG. 17 is a schematic diagram describing job allocation rotation in the printing system.

FIG. 18 illustrates a resource allocation table in the printing system.

### DESCRIPTION OF THE EMBODIMENTS

Various exemplary embodiments, features, and aspects of the invention will be described in detail below with reference to the drawings.

[Description of System Configuration]

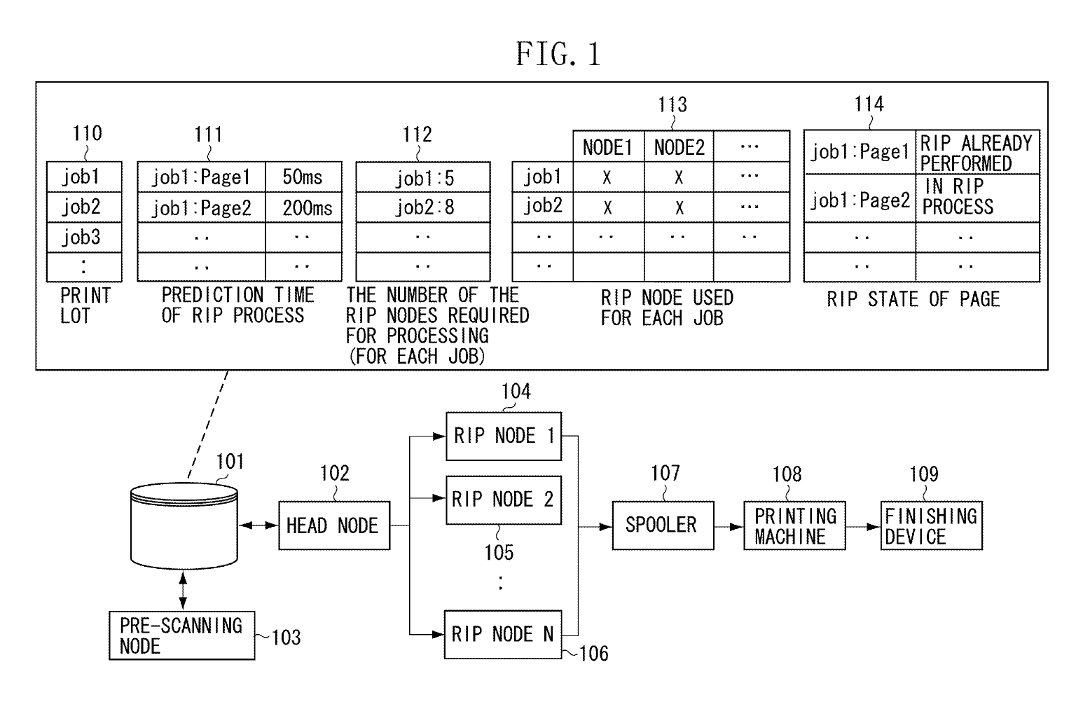

FIG. 1 is a block diagram describing a configuration of a printing system according to the first exemplary embodiment of the present invention. The present exemplary embodiment is an example of a system formed of a data processing apparatus using a RIP node, a pre-scan node, and a head node. The data processing apparatus includes a control board such as a central processing unit (CPU), a read only memory (ROM), and a random access memory (RAM), input-output device, a display apparatus, and a communication control device. The control board is equipped with a basic input/output system (BIOS) capable of setting a power saving control mode. Therefore, the RIP nodes described later can individually perform power saving control according to the instructions of a head node 102. Even if the data processing apparatus is configured as a server apparatus, it also follows the spirit of the present invention. There is described below an exemplary embodiment taking as an example a printing system including an information processing apparatus which receives at the same time a plurality of print jobs requiring a drawing processing, and drawing processing apparatuses capable of switching power saving modes according to the instructions of the information processing apparatus. A printing machine 108 acts as any of the drawing processing apparatuses, specifically, as a printing apparatus for printing image information drawn by any of the RIP nodes.

In FIG. 1, a storage 101 stores various types of information about a print lot 110, a prediction time of a RIP process 111, a number 112 of the RIP nodes required for the processing, a RIP node used for each job 113, and the RIP state of a page 114.

RIP nodes 104, 105, and 106 are calculation nodes for performing the RIP process of a page of the print job. A spooler 107 is a server for spooling the RIP-processed data. A head node 102 distributes pages to the RIP nodes 104, 105, and 106 to request the RIP nodes to RIP-process the pages. A pre-scanning node 103 performs pre-scanning processing. The printing machine 108 is adaptable to a roller paper. A finishing device 109 is a part of a system for performing post-processing of printing. The printing machine 108 can execute a print workflow processing conforming to a universal printer pre- and post-processing interface (UP) 3I standards. The UP3I standards are standards defining the inline connection of a processing machine after printing.

The head node 102 as an information processing apparatus has a function to start a series of printing processing for a plurality of the received print jobs and then allocate drawing processing for each page required for the received print jobs to any of drawing processing apparatuses (the RIP node 104, 105, 106). Furthermore, the head node 102 has a function to instruct a corresponding drawing processing apparatus to dynamically switch a power supply state between a drawing processing apparatus used for drawing each allocated page and a drawing processing apparatus not used for drawing each page among drawing processing apparatuses. A more specific processing is described later with reference to a flow chart.

The pre-scanning node 103 as an information processing apparatus has a function to predict the drawing processing time of each page of the received print job. The pre-scanning node 103 allocates the drawing processing apparatus for drawing each page among the drawing processing apparatuses according to the predicted drawing processing time of each page.

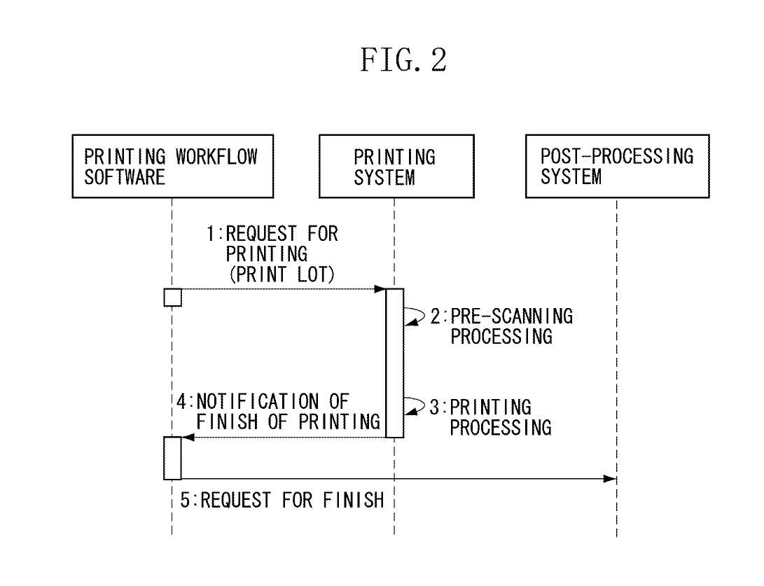

FIG. 2 is an operational sequence diagram of the printing system illustrated in FIG. 1. In FIG. 2, in sequence number 1, printing workflow software designates the print lot 110 and requests the printing system to perform printing.

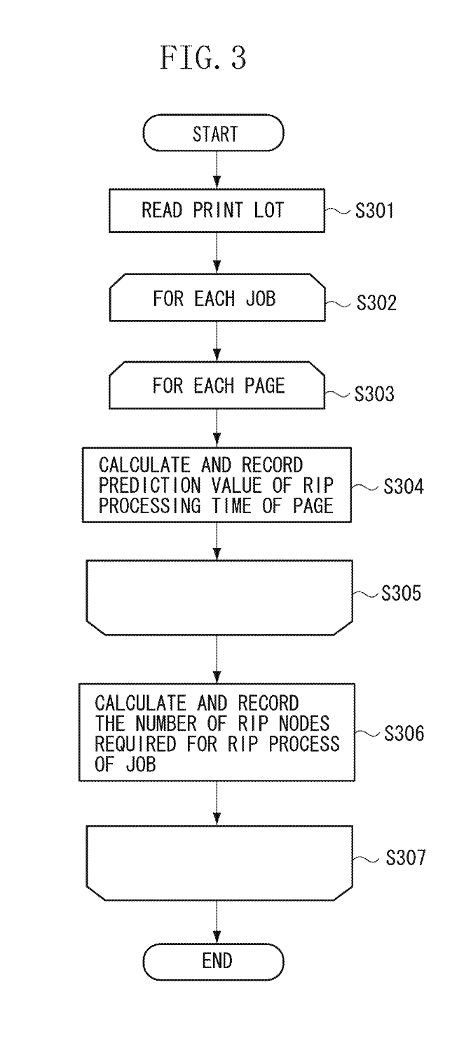

In sequence number 2, the printing system subjects all PDL jobs in the print lot 110 to pre-scanning processing on the pre-scanning node 103. The printing system has a RIP processing time calculating unit for calculating the RIP processing time in the pre-scanning processing. A flow chart of the pre-scanning processing is illustrated in FIG. 3.

FIG. 3 is a flow chart describing pre-scan processing in the printing system according to the present exemplary embodiment. Each step is realized by the CPU of the pre-scanning node 103 loading a program onto a RAM and executing the program. For the sake of convenience of description, the pre-scanning node 103 is described below as a control entity.

In step S301, the pre-scanning node 103 reads the designated print lot 110 from the storage 101. In step S302, the pre-scanning node 103 starts processing for calculating the number of the RIP nodes required for the RIP process of each job. In step S303, the pre-scanning node 103 starts processing for calculating a prediction value of the RIP processing time of a page. In step S304, the pre-scanning node 103 records the calculated RIP processing time in the prediction time of the RIP process 111. An existing method for calculating the load of the PDL process is used to estimate the RIP processing time of a page.

In step S305, the pre-scanning node 103 determines whether the calculation processing of the RIP processing time for each page is finished. If the pre-scanning node 103 determines that the calculation processing of the RIP processing time is not finished (NO in step S305), the pre-scanning node 103 returns the processing to step S303 to repeat the similar processing.

On the other hand, if the pre-scanning node 103 determines that the calculation processing of the RIP processing time for each page is finished (YES in step S305), the pre-scanning node 103 advances the processing to step S306. In step S306, the pre-scanning node 103 calculates the number of the RIP nodes required to RIP-process a target job at a speed of or higher than the printing machine using the processing time of each page acquired in step S304. Then, the pre-scanning node 103 records the number in a RIP node number 112 required for the processing in the storage 101.

In step S307, the pre-scanning node 103 determines whether the calculation processing of the RIP processing time for each job is finished. If the pre-scanning node 103 determines that the calculation processing of the RIP processing time is not finished (NO in step S307), the pre-scanning node 103 returns the processing to step S302 to repeat the similar processing.

If the pre-scanning node 103 determines that the calculation processing of the RIP processing time for each job is finished (YES in step S307), the pre-scanning node 103 ends the present processing.

A calculation equation used for calculating the RIP processing time by the pre-scanning node 103 is shown below. However, the following equation may be corrected to put flexibility into the processing:

The number of the RIP nodes=ceil(sum of processing time of all pages in a job divided by print speed),

where ceil (x) is the minimum integer equal to or greater than x (ceiling function).

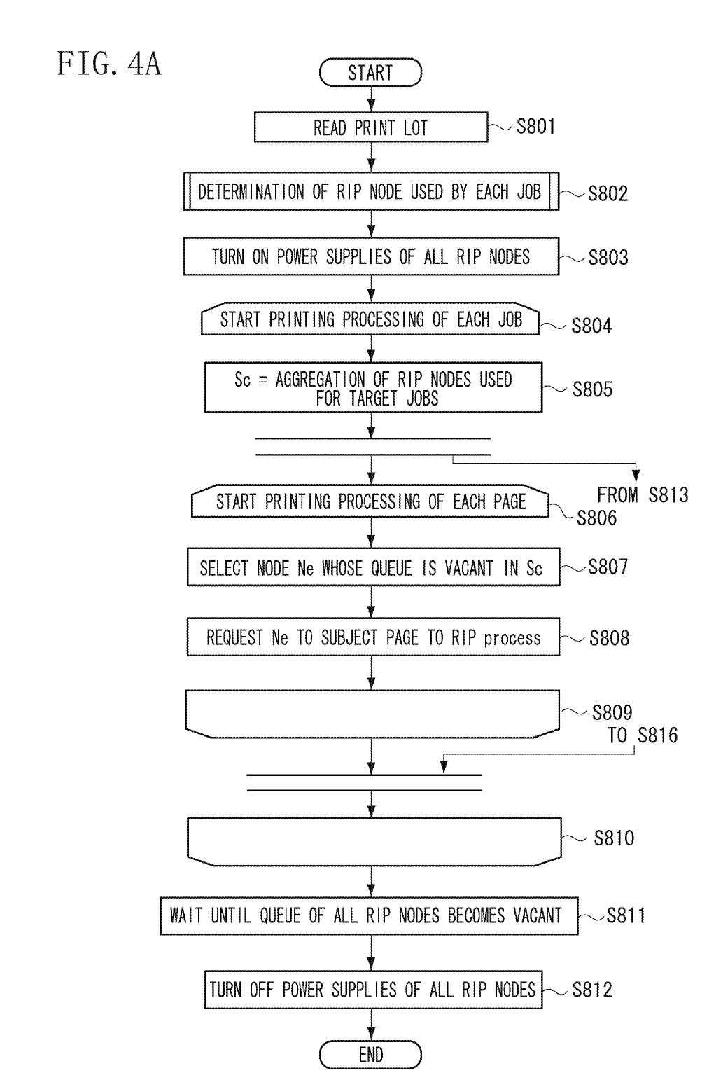

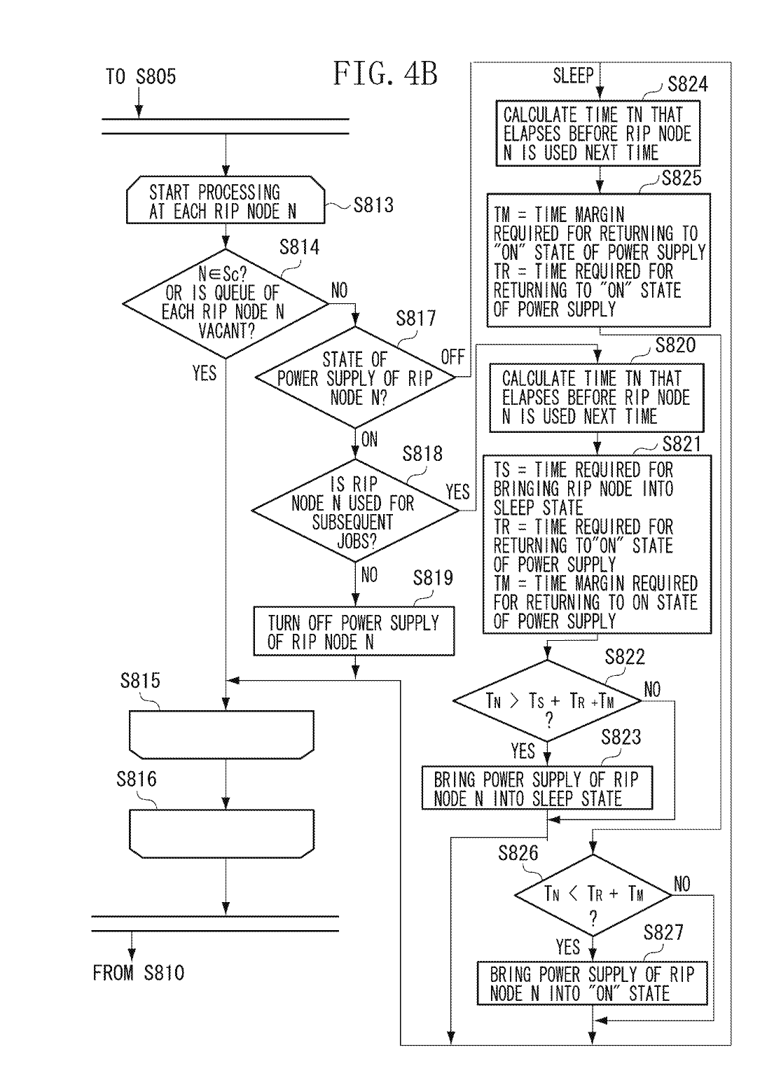

In sequence number 3 in FIG. 2, the printing system performs the printing processing of the print lot illustrated in FIG. 4.

FIG. 4 is a flow chart describing a method for processing data in the printing system according to the present exemplary embodiment. Each step is realized by the CPU of the head node 102 loading a program onto the RAM and executing the program. The head node 102 can be configured by a computer system equipped with a control board including a CPU, a ROM, and a RAM, a communication control unit, a display apparatus, and an input apparatus. The RIP node is also formed as a data processing apparatus including the similar hardware. The head node 102 is described below as a control entity.

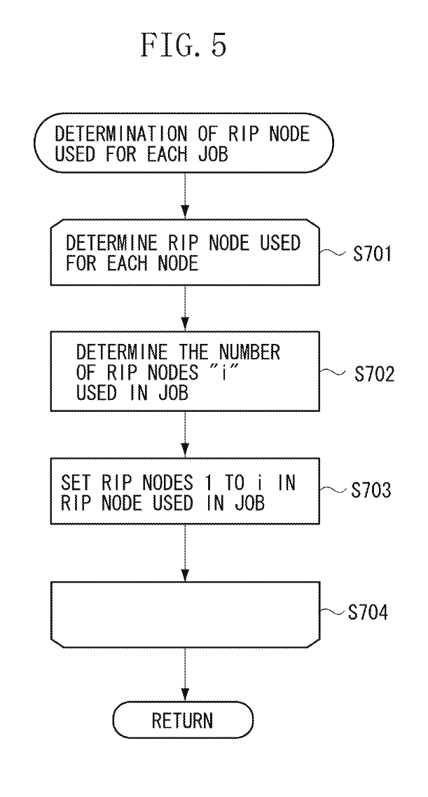

In step S801, the head node 102 reads the print lot 110 from the storage 101. In step S802, the head node 102 determines a RIP node group used for the RIP process with use of the RIP node number 112 required for the process and records the RIP node group in the RIP node used for each job 113. A flow chart for determining a RIP node group is illustrated in FIG. 5.

In step S803, the head node 102 turns on the power supplies of all RIP nodes 1 to N determined in step S802. Thus, in the present exemplary embodiment, before the head node 102 starts a series of printing processing for a plurality of the received print jobs, the head node 102 executes instructions for shifting the supply of power to all RIP nodes, from an OFF state to an ON state.

In step S804, the head node 102 starts the printing processing of each job and an aggregation of the RIP nodes used for target jobs is referred to as SC.

In step S806, the head node 102 starts the printing processing of each job and selects a RIP node Ne whose queue is vacant, among the aggregation SC. In step S808, the head node 102 requests the RIP node Ne to subject a page to the RIP process. In step S809, the head node 102 determines whether the RIP process of each page is ended. If the head node 102 determines that the RIP process of each page is not ended (NO in step S809), the processing is returned to step S806.

If the head node 102 determines that the RIP process of each page is ended (YES in step S809), in step S810, the head node 102 determines whether the RIP process of each job is ended.

If the head node 102 determines that the RIP process of each job is not ended (NO in step S810), the processing is returned to step S804 to repeat the similar processing.

If the head node 102 determines that the RIP process of each job is ended (YES in step S810), in step S811, the head node 102 waits until the queue of all RIP nodes becomes vacant. In step S812, the head node 102 turns off the power supplies of all RIP nodes and ends the present processing.

In step S813, the processing is started in each node whose power supply is to be turned on according to the instruction. In step S814, the head node 102 determines whether each RIP node N is included in the aggregation SC or the queue of each RIP node N is not vacant. If the head node 102 determines that each RIP node N is included in the aggregation SC or the queue of each RIP node N is not vacant (YES in step S814), in step S815, the head node 102 determines whether the processing in each RIP node started in step S813 is completed. If the head node 102 determines that the processing in each RIP node started in step S813 is not completed (NO in step S815), the processing is returned to step S813.

If the head node 102 determines that the processing in each RIP node started in step S813 is completed (YES in step S815), the head node 102 advances the processing to step S816 and determines whether all pages are to be subjected to the RIP process according to the request. If the head node 102 determines that all pages are not yet to be subjected to the RIP process according to the request (NO in step S816), the processing is returned to step S813. If the head node 102 determines that all pages are already to be subjected to the RIP process according to the request (YES in step S816), the processing proceeds to step S810.

If the head node 102 determines that each RIP node N is included in the aggregation SC or the queue of each RIP node N is vacant (NO in step S814), the processing proceeds to step S817.

In step S817, the head node 102 determines whether the power supply of the RIP node N is in an ON state, a sleep state, or an OFF state. In the present exemplary embodiment, the head node 102 issues the following instructions to the drawing processing apparatus. More specifically, the head node 102 instructs the corresponding drawing processing apparatus to dynamically switch the state of power supply to the drawing processing apparatus not used for drawing each page from the ON state of power supply to the sleep state, or from the ON state of power supply to the OFF state of power supply.

In step S817, if the head node 102 determines that the power supply of the RIP node N is in the ON state, in step S818, the head node 102 determines whether the RIP node N is used for subsequent jobs. If the head node 102 determines that the RIP node N is not used for subsequent jobs (NO in step S818), the head node 102 instructs the RIP node N to turn off the power supply of the RIP node N and advances the processing to step S815.

If the head node 102 determines that the RIP node N is used for subsequent jobs (YES in step S818), in step S820, the head node 102 calculates time TN that elapses before the RIP node N is used next time, based on a calculation equation described later.

In step S821, the head node 102 determines time TS required for bringing the RIP node into a sleep state, time TR required for returning the RIP node to an ON state of power supply, and time margin TM when the RIP node is shifted from the sleep state to the ON state. In step S822, the head node 102 determines whether the time TN is longer than the sum of the time TS, the time TR, and the time TM. If the head node 102 determines that the time TN is not longer than the sum of the time TS, the time TR, and time TM (NO in step S822), the processing proceeds to step S815.

If the head node 102 determines that the time TN is longer than the sum of the time TS, the time TR, and the time TM (YES in step S822), the head node 102 instructs the RIP node N to bring the power supply of the RIP node N into a sleep state and advances the processing to step S815.

In step S817, if the head node 102 determines that the power supply of the RIP node N is in a sleep state, in step S824, the head node 102 calculates time TN that elapses before the RIP node N is used next time. In step S825, the head node 102 determines the time TR required for returning the RIP node to an ON state of power supply and the margin time TM required for shifting the RIP node from the sleep state to the ON state. In step S826, the head node 102 determines whether the time TN is shorter than the sum of time TM and the time TR. If the head node 102 determines that the time TN is not shorter than the sum of the time TM and the time TR (NO in step S826), the processing proceeds to step S815.

If the head node 102 determines that the time TN is shorter than the sum of the time TM and the time TR (YES in step S826), the head node 102 instructs the RIP node N to turn on the power supply of the RIP node N and advances the processing to step S815.

FIG. 5 is a flow chart describing a method for processing data in the printing system according to the present exemplary embodiment. The present processing corresponds to a detailed process for determining the RIP node in step S802 in FIG. 4. Each step is realized by the CPU of the head node 102 loading a program onto the RAM and executing the program. The head node 102 is described below as a control entity. The head node 102 can be configured by a computer system equipped with a control board including a CPU, a ROM, and a RAM, a communication control unit, a display apparatus, and an input apparatus. The RIP node is formed as a data processing apparatus including the similar hardware.

In step S701, the head node 102 starts processing for determining the RIP node used in each job.

In step S702, the head node 102 determines the number of the RIP nodes “i” used in a job. In step S703, the head node 102 sets the RIP nodes 1 to i as the RIP node used in a job.

In step S704, the head node 102 determines whether the process for determining the RIP node for each job is ended. If the head node 102 determines that the process is not ended (NO in step S704), the head node 102 returns the processing to step S701. If the head node 102 determines that the process is ended (YES in step S704), the head node 102 ends the present processing.

Thus, the printing system in the present exemplary embodiment requires a certain period of time (time TM) when the RIP node is shifted from a sleep state to an ON state of power supply at a boundary between print jobs.

Therefore, in step S825, it is required to start shifting beforehand in consideration of the time margin (time TR and TM in step S825). The RIP process is not actually performed during the time margin and extra power is consumed. For this reason, the algorithm illustrated in FIG. 5 operates to minimize the number of times of shifting the states. The power consumptions of the RIP nodes are presumed to be equal to each other.

The above steps S806 to S809 represent the processing for distributing each page to the RIP nodes. The RIP nodes 1 to N include queues for storing requests for performing the RIP process from the head node 102 and have functions to notify the head node 102 of the state of a queue in response to an inquiry of the head node 102. In step S807, the function is used to monitor the queue of each RIP node. In step S808, the head node 102 requests the RIP node Ne whose queue becomes vacant to subject a page to the RIP process. The RIP node pulls out the request for performing the RIP process from the queue, executes the RIP process using a RIP process execution function, and notifies the head node 102 of state of the RIP process of each page. The head node 102 records the state of the RIP process in the RIP state 114 of a page.

In steps S813 to S816, the state of the RIP node is polled to bring the power supply of the RIP node not used in each job into the sleep state (steps S820 to S823). The head node 102 turns on the power supply of the RIP node used in the next job (steps S824 to S827) and turns off the power supply of the RIP node not used in the subsequent jobs (step S819). The interval of the polling can be configured.

In step S820, the head node 102 determines the time TN that elapses before the target node is used next time, from the following equation where a job in process is the i-th and the job using the target node next time is the j-th: Σn=i . . . j−1: (estimated time in which the page of a job n yet to be subjected to the RIP process is processed).

The values i and j are obtained from the RIP node used for each job 113. The estimated time in which the page yet to be subjected to the RIP process is processed is obtained from the prediction time of the RIP process 111 and the RIP state of a page 114.

In steps S804 to S810, the head node 102 requests the RIP node Ne to subject the pages of all print jobs in the print lot to the RIP process. In step S811, the head node 102 waits until the queue of the RIP node becomes vacant. In step S812, the head node 102 turns off the power supply of all RIP nodes.

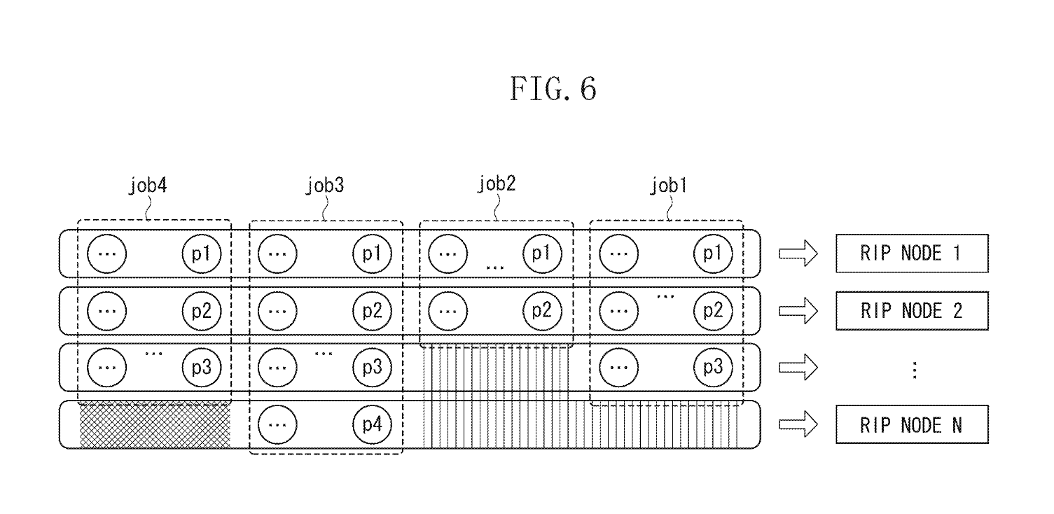

An example of distribution of pages to the RIP nodes and the control of power supply to the RIP nodes is illustrated in FIG. 6.

FIG. 6 is a schematic diagram illustrating a state of the power supply of each RIP node in the printing system according to the present exemplary embodiment. The example shows that each page of jobs 1 to 4 is sequentially distributed to the RIP node on the right and subjected to the RIP process.

In FIG. 6, the power supply of the RIP node N not used for the RIP process is in a sleep state (area shown by vertical lines). In a job 4, the power supply of the RIP node N not used afterward is in an OFF state (shaded area).

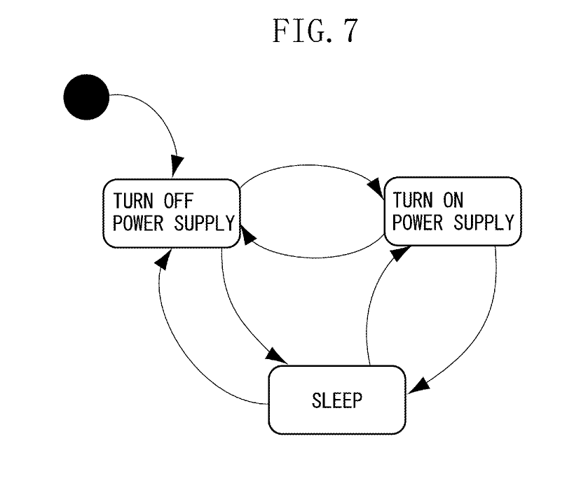

Each RIP node includes a power supply control mechanism for controlling the power supply using a WakeOnLAN function. The RIP node receives a request for controlling the power supply, from the outside and shifts among “power supply ON state,” “sleep state,” and “power supply OFF state” according to the state shift illustrated in FIG. 7. A plurality of sleep states may be provided in accordance with advanced configuration and power interface (ACPI) standards.

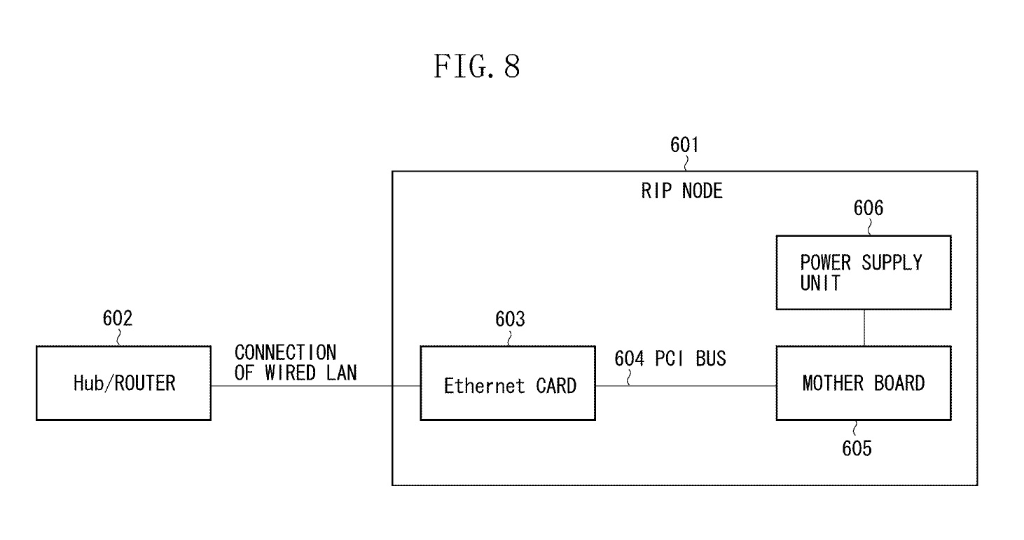

FIG. 8 is a block diagram of a power supply mechanism of the RIP node in the printing system illustrated in the present exemplary embodiment. The RIP nodes 104 to 106 illustrated in FIG. 1 include the similar power supply mechanism to execute power saving control by changing a power supply state to three states such as ON, OFF, and sleep according to instructions of the head node 102. Each state is shifted in accordance with the ACPI standards.

In FIG. 8, a RIP node 601 is connected to a hub/router 602 via a wired LAN, and an Ethernet (registered trademark) card 603 is connected to a mother board 605 via a peripheral component interface (PCI) local bus 604. A power supply unit 606 corresponds to ATX2.01. The mother board 605 is equipped with the BIOS capable of setting a power control mode.

The printing system of the present exemplary embodiment has a function to display power consumption and calculates a prediction value of power consumption for each time unit after pre-scanning.

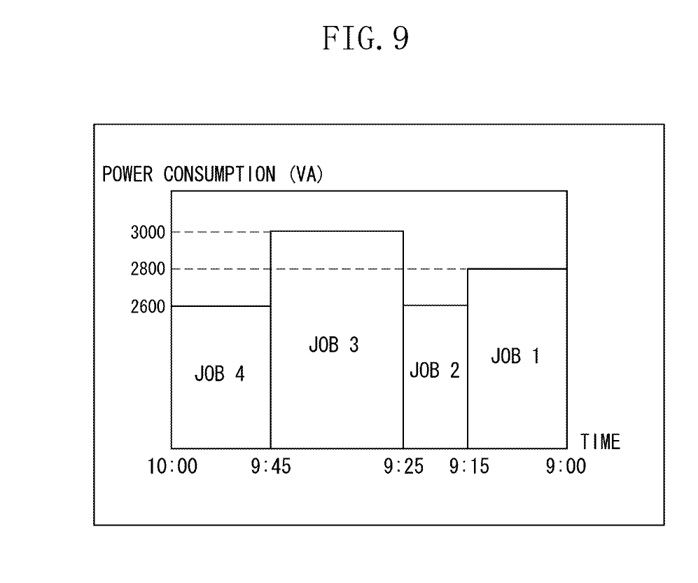

A power consumption state screen illustrated in FIG. 9, for example, is displayed on the display apparatus of the head node 102. This allows a user to refer to a prediction value of power consumption of each job. The current value of power consumption may be displayed during printing processing or past history may be displayed or reported in any timing.

In other words, the head node 102 has a function to calculate the amount of power consumption associated with the drawing processing of each job from power consumption information per unit time specified by the allocated RIP node. A change in the calculated amount of power consumption accompanying the drawing processing of each job and a drawing processing elapsed time are displayed in association with each other. The head node 102 performs control to display a screen indicating the change in the calculated amount as illustrated in FIG. 9 on the display apparatus.

In the system configuration illustrated in FIG. 1, the pre-scanning node 103 is separated from the head node 102, however, pre-scanning may be performed by using the head node 102.

In the first exemplary embodiment, the printing processing is performed according to the sequence of print jobs of the print lot 110. A second exemplary embodiment relates to a power saving option in which the RIP process is performed in descending order of the number of the RIP nodes used for a job in executing the printing processing, as described below.

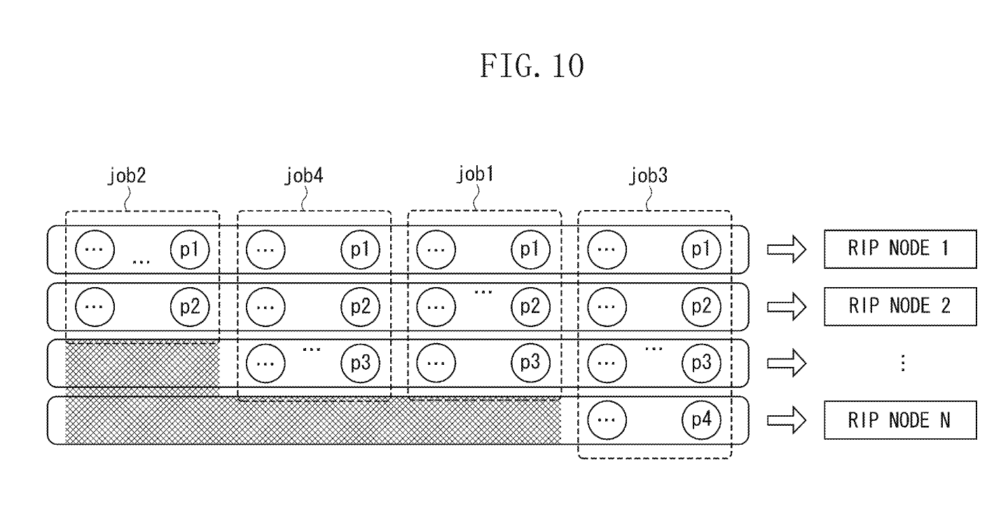

FIG. 10 is a schematic diagram illustrating a state of the power supply of each RIP node in the printing system according to the present exemplary embodiment. FIG. 10 illustrates an example of the RIP process in which a job is executed in descending order of the number of the RIP nodes to be used.

In the algorithm of printing processing for the printing system according to the present exemplary embodiment, the power supply of the RIP node not used in the subsequent jobs is turned off, so that the power supply of the RIP node not used is sequentially turned off as illustrated in FIG. 10.

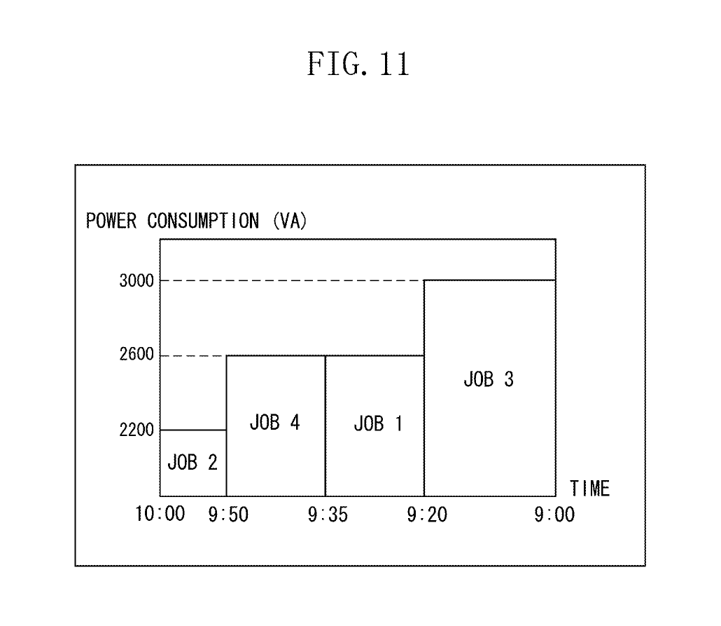

This eliminates the need for turning on the power supply or bringing the power supply into the sleep state in the subsequent processing in the printing lot, which maximizes the power saving effect. As a result, as illustrated in FIG. 11, the amount of power consumption is decreased as compared with power consumption in FIG. 9. Both of the charts illustrated in FIGS. 9 and 10 may be at the same time displayed on the display apparatus of the head node 102 to visualize the reduced amount of power consumption.

The post-process is notified of a change of the order of print jobs, so that inconvenience is not caused in finishing in the post-process. In the present exemplary embodiment, the change of jobs is described, but the order of pages in the jobs may be changed using the power saving option setting unit.

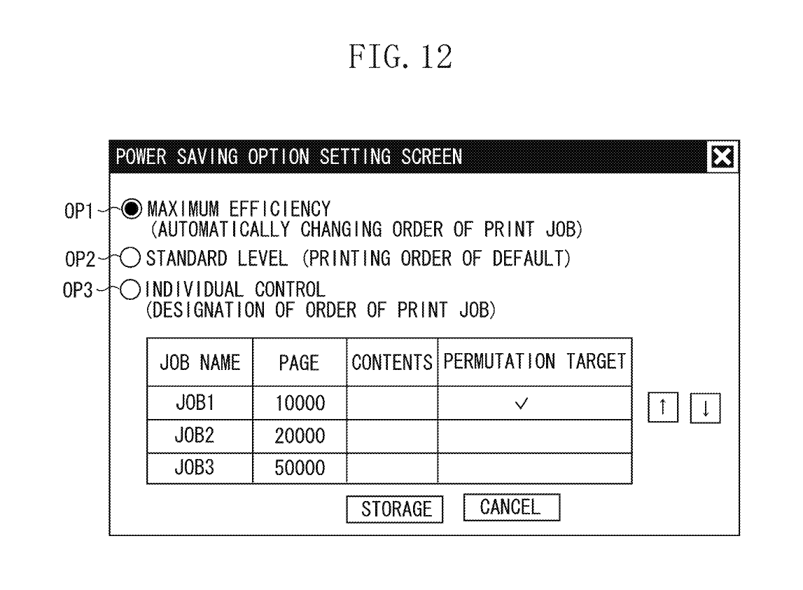

More specifically, the user can set the operation parameters of power consumption using the UI screen (an option reception screen) illustrated in FIG. 12.

The power saving option setting unit takes the form of a setting file, an application programming interface (API), or a setting screen. In FIG. 12, the power saving option setting unit provides three options: an option in which the order of print jobs is automatically changed; an option in which the RIP process is performed in the order of print jobs in the original print lot; and an option in which the order of print jobs is arbitrarily changed.

In the present exemplary embodiment, the head node 102 has a function to receive an option of changing the order of drawing processing for each received print job. As the option, the head node 102 receives any of a first option OP1 associated with levels of a power saving effect, a second option OP2 associated with the order of reception of print jobs, and a third option OP3 associated with the order of drawing processing set by the user.

FIG. 12 is an option selection screen for receiving the first, second, and third options OP1, OP2, and OP3. The user selects any of radio buttons associated with the first, second, and third options OP1, OP2, or OP3 to instruct the head node 102 to perform the option on the order of drawing processing.

In the first and second exemplary embodiments, the RIP process and the power supply control are performed for each RIP node, however, the present invention can also be applied to the configuration in which the RIP process and the power supply control are performed for each CPU or CPU core. The following describes a third exemplary embodiment of this configuration.

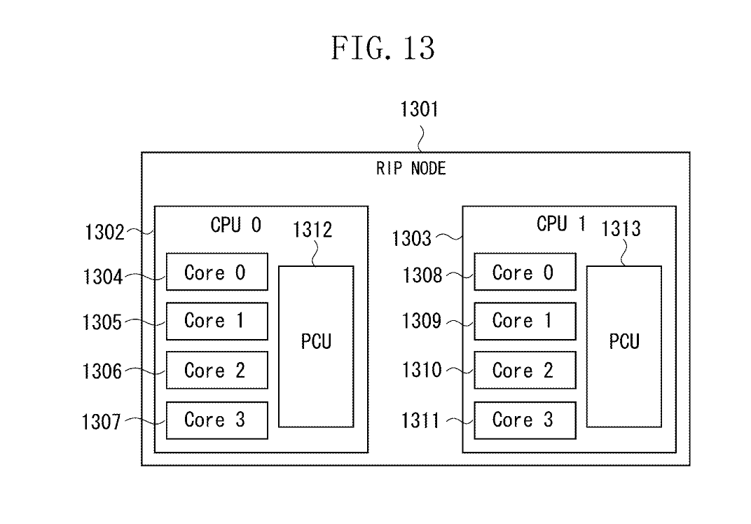

FIG. 13 is a block diagram illustrating a configuration of the RIP node of the printing system according to a third exemplary embodiment of the present invention.

In FIG. 13, a RIP node 1301 includes CPUs 1302 and 1303. The CPUs 1302 and 1303 include CPU cores 1304 to 1307 and cores 1308 to 1311 respectively. The RIP node 1301 has a function to control power supply ON/OFF for each CPU core via a power supply control units (PCU) 1312 and 1313. Thereby, the PCU 1312 and 1313 can provide the corresponding CPU core with instructions for dynamically switching a power supply state between the CPU core used for drawing each allocated page and the CPU core not used for drawing each page among a plurality of the CPU cores in accordance with instructions from the head node 102.

A different page is subjected to parallel RIP process for each CPU in the RIP node 1301 to reduce the number of the RIP nodes to be operated and save power consumption. An equation for calculating the number of the RIP nodes in step S306 illustrated in FIG. 3 in the present exemplary embodiment is shown below:

a number of the RIP nodes=ceil(sum of page processing time/printing speed/the number of the CPUs in the node),

where ceil (x) is the minimum integer equal to or greater than x (ceiling function). In the present exemplary embodiment, the RIP node subjects each page to the RIP process using a plurality of CPU cores of one CPU.

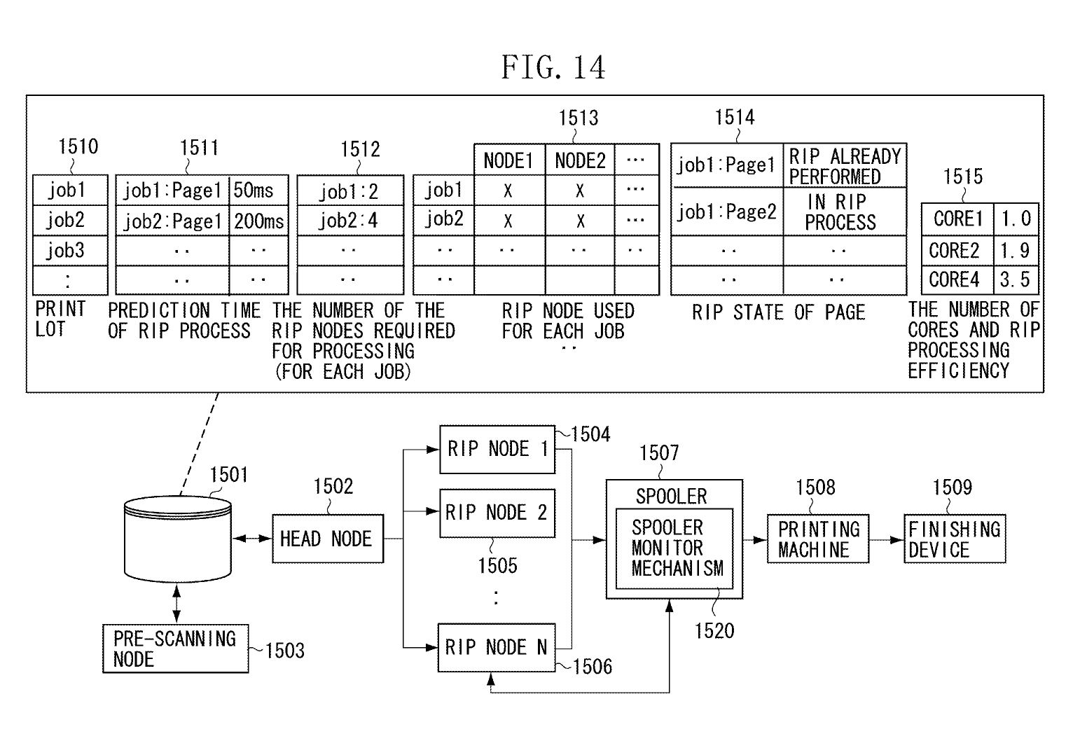

FIG. 14 is a block diagram describing a configuration of a printing system according to the present exemplary embodiment.

In FIG. 14, the number of the CPU cores used by the head node 1502 is determined such that the RIP process time of each page can be less than the upper limit (print time per page×the number of the RIP nodes×the number of the CPUs) based on a corresponding table 1515 between the number of cores and a rip processing efficiency. This is default algorithm determining the number of the CPU cores.

For example, if the print time per page is 30 ms, the number of the RIP nodes is two and the number of the CPUs to be used is also two, the upper limit of the RIP process time is 120 ms. If the RIP process prediction time of a target page is 180 ms, when the target page is subjected to the RIP process using two cores, the RIP process can be performed in about 95 ms according to the corresponding table 1515.

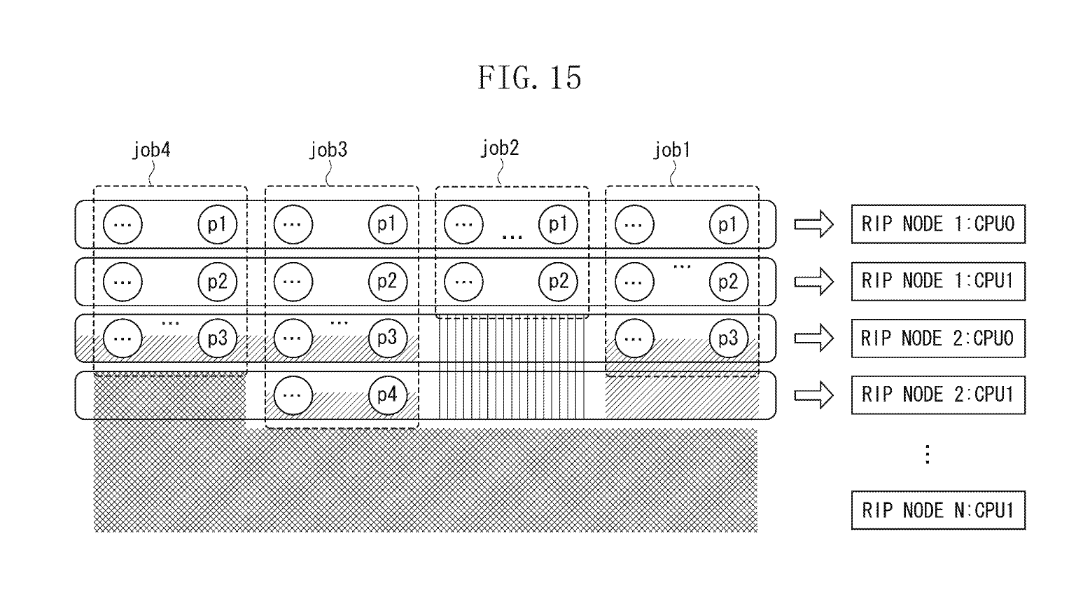

FIG. 15 is a schematic diagram illustrating a state of the power supply of each RIP node in the printing system according to the present exemplary embodiment. FIG. 15 illustrates an example in which a plurality of drawing processing units is configured by a processor system including a multi-core.

In FIG. 15, a shaded area indicates that the power supply of the RIP node not in use is turned OFF, and a vertical-line area indicates that the power supply of the RIP node not in use is brought into the sleep state. In a hatched area in the figure, the power supply of the CPU core not in use is turned OFF.

A spooler 1507 includes a spooler monitor mechanism for monitoring the volume and the flow rate of the spooled data. In the printing processing, the volume of the spooled data is periodically acquired from the spooler monitor mechanism in the repetitious processing in steps S813 to S816 illustrated in FIG. 4. If the volume of the spooled data is decreased, the spooler 1507 issues an alert to each RIP node.

Basically, the RIP node determines the number of CPU cores used for the RIP process based on the default algorithm. However, if the RIP node receives the alert, the RIP node increases the number of CPU cores used for the RIP process of each page.

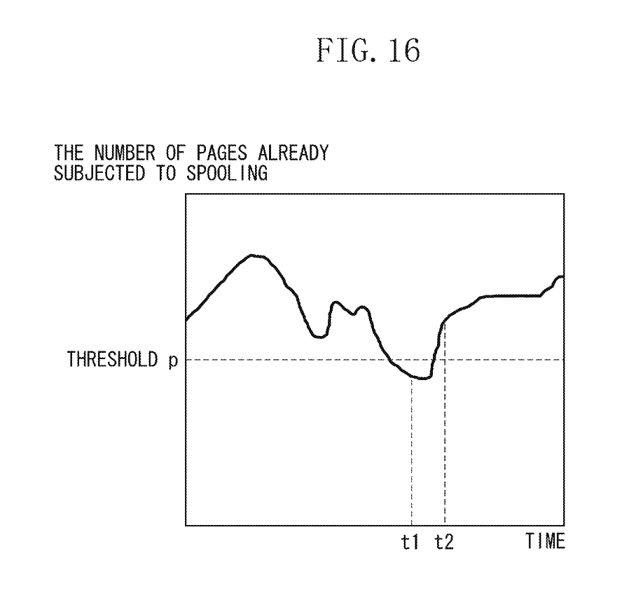

FIG. 16 illustrates an example of the volume of the spooled data monitored by the spooler monitor mechanism.

In FIG. 16, the printing processing detects that the number of spooled pages becomes smaller than a threshold p at time t1 and issues an alert to the RIP node. The RIP node which has received the alert performs the RIP process using all CPU cores in the CPU. The printing processing detects that the number of spooled pages becomes larger than the threshold p at time t2 and instructs the RIP node to operate under the default algorithm. The instructed RIP node again determines the number of CPU cores used for the RIP process based on the default algorithm. A condition for issuing an alert may be based on the flow rate of data instead of the volume of data.

In a forth exemplary embodiment of the present invention, allocation is rotated to equalize an opportunity of use for each CPU when the CPU used for the RIP process is determined based on the number of the RIP nodes calculated in the pre-scanning processing.

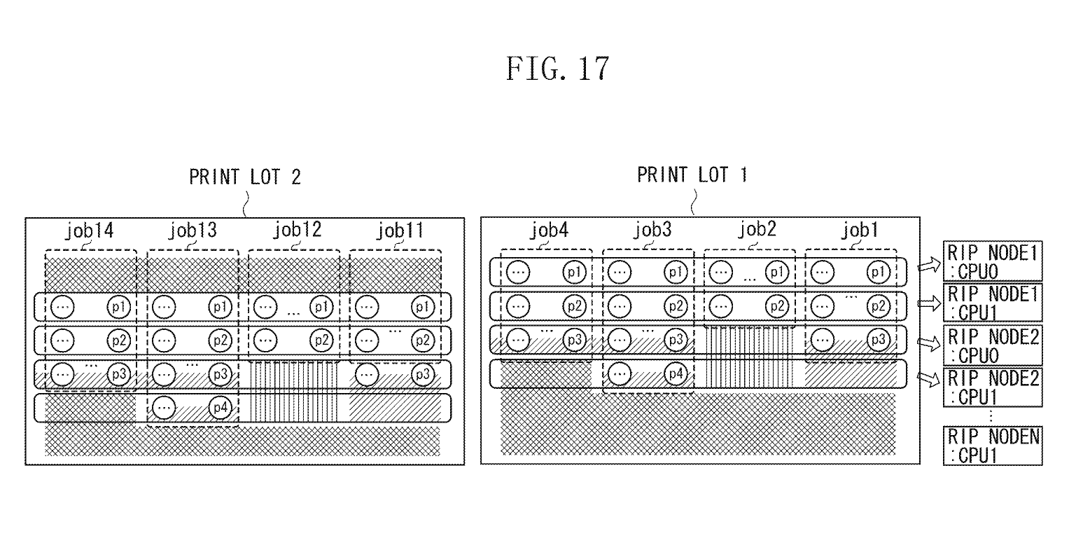

FIG. 17 is a schematic diagram of job allocation rotation for the printing system according to the present exemplary embodiment. FIG. 17 is an example in which allocation of CPUs to be used is rotated on a print-lot basis.

In FIG. 17, in the print lot 1, the RIP process is preferentially allocated in the order starting from the CPU0 of the RIP node 1. In the print lot 2, the RIP process is allocated in the order starting from the CPU1 of the RIP node 1.

Thus, hardware allocated to the RIP process is sequentially rotated to prevent a specific hardware from being excessively worn.

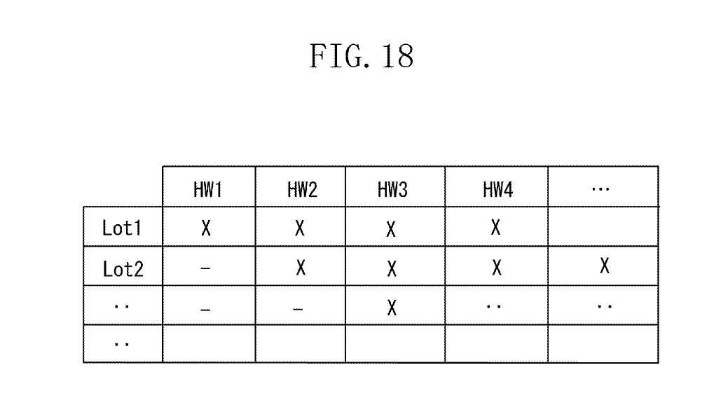

The printing system according to the present exemplary embodiment includes a resource allocation table illustrated in FIG. 18 in the storage 101 and records the resource allocation on a print-lot basis.

Further, the rotation may be performed on a plurality-of-print-lots basis or on a certain operating time basis. Alternatively, the rotation may be performed on a node basis or on a CPU core basis instead of on a CPU basis. Still alternatively, execution time or the number of times of execution of the RIP process or the number of times of shift to the ON state, the sleep state, or the OFF state of power supply may be used as an index when using each CPU.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-057516 filed Mar. 16, 2011, which is hereby incorporated by reference herein in its entirety.

What is claimed is:

1. A printing system comprising:
an information processing apparatus configured to receive at the same time a plurality of print jobs requiring drawing processing;
a plurality of drawing processing apparatuses capable of switching power saving modes according to the instructions of the information processing apparatus; and
a printing apparatus configured to print image information drawn by any of the drawing processing apparatuses;
wherein the information processing apparatus includes:
an allocation unit configured to allocate drawing processing on a page basis required for each received print job to any of a plurality of the drawing processing apparatuses after a series of printing processing for a plurality of the received print jobs is started; and
a control unit configured to instruct a corresponding drawing processing apparatus to dynamically switch a power supply state between the drawing processing apparatus used for drawing each page allocated by the allocation unit and the drawing processing apparatus not used for drawing each page, among a plurality of the drawing processing apparatuses.

2. The printing system according to claim 1, wherein the information processing apparatus further includes a prediction unit configured to predict a drawing processing time of each page of the received print job and the allocation unit allocates a drawing processing apparatus for drawing each page among a plurality of the drawing processing apparatuses according to the drawing processing time of each page predicted by the prediction unit.

3. The printing system according to claim 1, wherein the control unit issues instructions for shifting the power supply to all drawing processing apparatuses from an OFF state to an ON state before starting a series of printing processing for a plurality of the received print jobs.

4. The printing system according to claim 1, wherein the control unit instructs the corresponding drawing processing apparatus to dynamically switch the state of power supply to the drawing processing apparatus not used for the drawing processing of each page from the ON state of power supply to a sleep state, or from the ON state of power supply to the OFF state of power supply.

5. The printing system according to claim 1, further comprising:
a calculation unit configured to calculate the amount of power consumption associated with the drawing processing of each job from power consumption information per unit time specified by the allocated drawing processing apparatus; and
a display unit configured to display the state of change in the amount of power consumption in the drawing processing of each job calculated by the calculation unit in association with time elapsed in the drawing processing.

6. The printing system according to claim 1, further comprising an option reception unit configured to receive an option for changing the order of drawing processing for each received print job.

7. The printing system according to claim 6, wherein the option reception unit displays an option reception screen for receiving any of a first option associated with the level of a power saving effect, a second option associated with order in which a print job is received, and a third option associated with the order of drawing processing set by a user.

8. The printing system according to claim 1, wherein a plurality of the drawing processing unit is constituted by a processor system including a multi-core.

9. A method for controlling power in a printing system comprising:
an information processing apparatus configured to receive at the same time a plurality of print jobs requiring drawing processing;
a plurality of drawing processing apparatuses capable of switching power saving modes according to the instructions of the information processing apparatus; and
a printing apparatus configured to print image information drawn by any of the drawing processing apparatuses;
wherein the method in the information processing apparatus includes:
allocating drawing processing on a page basis required for each received print job to any of a plurality of the drawing processing apparatuses after a series of printing processing for a plurality of the received print jobs is started; and
instructing a corresponding drawing processing apparatus to dynamically switch a power supply state between the drawing processing apparatus used for drawing each allocated page and the drawing processing apparatus not used for drawing each page, among a plurality of the drawing processing apparatuses.

10. A program for causing a computer to execute the method for controlling power according to claim 9.
